(19) United States
(12) Patent Application Publication
(10) Pub. No.: US 2014/0375518 A1
(43) Pub. Date: Dec. 25, 2014

(54) AMPLITUDE TAPERED SWITCHED BEAM ANTENNA SYSTEMS

(71) Applicant: Radio Frequency Systems, Inc., Meriden, CT (US)

(72) Inventors: Charles M. Powell, Vernon, CT (US); Raja Reddy Katipally, Cheshire, CT (US)

(73) Assignee: Radio Frequency Systems, Inc., Meriden, CT (US)

(21) Appl. No.: 13/921,990

(22) Filed: Jun. 19, 2013

(51) Int. Cl. H01Q 21/00; H01Q 9/16

(52) U.S. Cl. CPC H01Q 21/0006; H01Q 9/16
USPC 343/816; 343/853

(57) ABSTRACT

Switched beam antenna systems are disclosed. The disclosed antenna systems include an antenna having multiple, co-linear arrays of electromagnetic radiating elements and a Butler Matrix feed network that feeds the antenna. Each of the arrays of electromagnetic radiating elements includes an identical number of radiating elements. At least one antenna port of the Butler Matrix feed network is connected to a power divider/combiner to split the signal strength at the at least one antenna port such that signal power is distributed unequally among the arrays of electromagnetic radiating elements. Power is distributed among the arrays in a manner that provides an improved balance of side lobe suppression and overall antenna gain.

### BACKGROUND

Switched beam antenna systems employing Butler Matrix feed networks are well known. In a basic type of conventional switched beam antenna system, a Butler Matrix feed network has N antenna ports, where ‘N’ is a number greater than one, feeding (when transmitting signals) or fed by (when receiving signals) N arrays or columns of radiating elements. The Butler Matrix feed network divides signal power equally amongst the arrays of radiating elements and provides different phase progressions depending on which receiver/transmitter port of the Butler Matrix feed network is used. By varying the phase progressions, the main beam of the antenna can be ‘switched’ from one point to another.

FIG. 1 shows an exemplary, basic conventional stitched beam antenna system 10 including a switched beam antenna 20, a Butler Matrix feed network 50 and one or more radio receivers and/or radio transmitters 100. The antenna 20 includes three co-linear arrays (or “columns”) 22, 24, 26 of associated electromagnetic radiating elements 37 positioned with respect to an electrically conductive backplate 38. The co-linear antenna arrays 22, 24, 26 include a first outer array 22, a center array 24 and a second outer array 26. The electromagnetic radiating elements 24 may be dipole radiating elements (“dipoles”) or other types of radiating elements. The Butler Matrix feed network 50 is a three-way device having three antenna ports 52, 54, 56 and three radio receiver/transmitter ports 60, 62, 64.

The antenna ports 52, 54, 56 are each connected to a respective one of the co-linear arrays 22, 24, 26 by cables 59 and connectors 39 associated with each array. The receiver/transmitter ports 62, 64, 66 are connected to one or more radio receivers and/or radio transmitters 100 by cables 67.

The antenna system 20 is configured such that energy is radiated or received from each co-linear array 22, 24, 26 at equal power.

A shortcoming of systems like system 20 is that equal power division among the arrays of radiating elements results in high side lobe levels, which wastes energy and may cause interference with other equipment. Accordingly, a number of solutions have been developed in the prior art to provide uneven distribution of power from a Butler Matrix feed network in order to minimize side lobe levels of the antenna beam pattern.

One known solution is to “pair” adjacent receiver/transmitter ports of an N-way Butler Matrix feed network, which creates a binomial power distribution across the N antenna ports to feed (when transmitting signals) or be fed by (when receiving signals) N radiating element arrays. This solution reduces the number of antenna beams to N/2. Moreover, the resulting binomial amplitude taper is highly inefficient and provides a wider beamwidth than is typical, which reduces the gain of the antenna.

Another known solution is to connect power dividers/combiners to two of the antenna ports of a four-way Butler Matrix feed network in order to feed signals to, or receive signals from, six co-linear arrays of dipoles. The power dividers/combiners each include two power divider/combiner antenna ports. In each power divider/combiner, one of the power divider/combiner antenna ports is connected to an outermost array of dipoles and the other power divider/combiner antenna port is connected to an array of dipoles that is adjacent the outermost array of dipoles. Power is distributed evenly across the two power divider/combiner antenna ports of each power divider/combiner such that the outermost arrays of dipoles receive the same amount of power as their adjacent arrays of radiating elements. In an effort to reduce side lobe levels, the outermost arrays of dipoles are provided with a lower number of radiating elements than their adjacent arrays of dipoles through a technique known as aperture tapering. However, aperture tapering is inefficient because switched beam arrays operate best when each adjacent array of dipoles has the same number of dipoles. When the number of dipoles differs between adjacent arrays, the beam patterns of each array do not add up in phase, side lobe levels are higher than desired and the gain of the antenna is compromised.

Accordingly, it is desirable to provide switched beam antenna systems that address the shortcomings of the prior art and provide an improved balance between side lobe suppression and overall antenna gain.

### SUMMARY OF THE INVENTION

The disclosure is related to various switched beam antenna systems including a phased array feed networks and multiple-array antennas configured to create multiple antenna beams. The disclosed antenna systems provide an improved combination of side lobe suppression and antenna gain.

According to an embodiment of the invention, an antenna system includes a multi beam antenna and a phased array feed network. The multi-beam antenna may include a plurality of co-linear arrays positioned with respect to an electrically conductive backplane. The plurality of co-linear arrays may include at least one central co-linear array and two outer co-linear arrays positioned outside of the at least one central co-linear array. Each co-linear array of the plurality of co-linear arrays may have one or more electromagnetic radiating elements.

The phased array feed network may include a plurality of radio receiver/transmitter ports configured to be connected to at least one radio receiver or transmitter, and a plurality of antenna ports connected to the plurality of co-linear arrays.

The antenna system may include one or more power dividers/combiners connecting a designated antenna port among the plurality of antenna ports to at least two co-linear arrays among the at least one central co-linear array and the two outer co-linear arrays. The antenna system may be configured to split a signal power of the designated antenna port such that signal power provided to the antenna decreases from the at least once central co-linear array to the two outer co-linear arrays.

According to another embodiment, a method of operating an antenna system is provided. The method may include implementing a multi-beam antenna comprising a plurality of co-linear arrays positioned with respect to an electrically conductive backplane. Each co-linear array of the plurality of co-linear arrays may include one or more electromagnetic radiating elements. The plurality of co-linear arrays may include at least one central co-linear array and two outer co-linear arrays positioned outside of the at least one central co-linear array. The method may further include implementing a phased array feed network. The phased array feed network may include a plurality of radio receiver/transmitter ports configured to connect to at least one radio receiver or transmitter, and a plurality of antenna ports configured to connect to the plurality of co-linear arrays. The method may further include using one or more power dividers/combiners to connect one or more designated antenna ports among the plurality of antenna ports to at least two co-linear arrays among the at least one central co-linear array and the two outer co-linear arrays. The one or more power dividers/combiners may be operated to split a signal power of the one or more designated antenna ports and thereby decrease signal power provided to the antenna from the at least one central co-linear array to the two outer co-linear arrays.

Other features and advantages of the invention will be apparent to those skilled in the art in view of the following detailed description and appended drawings.

### BRIEF DESCRIPTION OF THE DRAWINGS

FIG. 1 illustrates a conventional antenna system including a three-way Butler Matrix feed network.

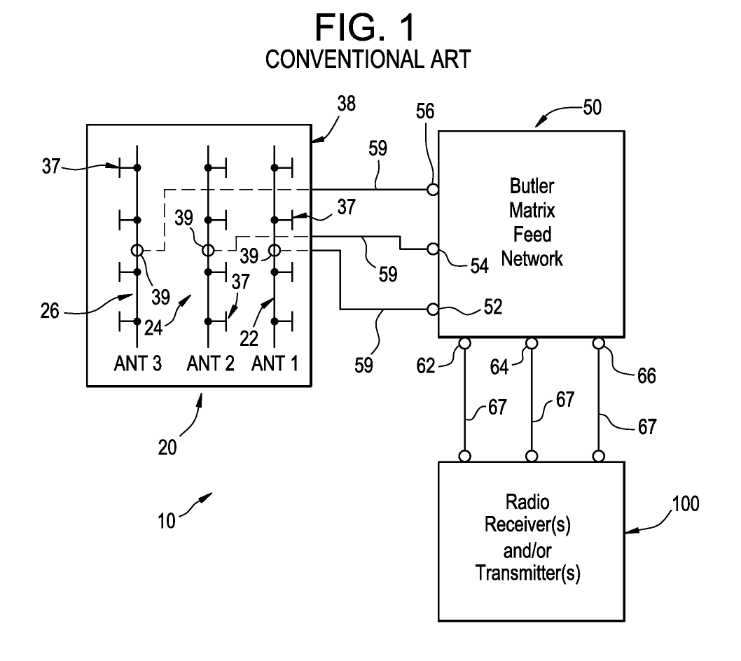

FIG. 2 illustrates an antenna system including a three-way Butler Matrix feed network connected four arrays of electromagnetic radiating elements, according to an embodiment of the invention.

FIG. 3 illustrates an antenna system including a three-way Butler Matrix feed network connected five arrays of electromagnetic radiating elements, according to another embodiment of the invention.

FIG. 4 illustrates an antenna system including a three-way Butler Matrix feed network connected to six arrays of electromagnetic radiating elements, according to another embodiment of the invention.

FIG. 5 illustrates an antenna system including a four-way Butler Matrix feed network connected to five arrays of electromagnetic radiating elements, according to another embodiment of the invention.

FIG. 6 illustrates an antenna system including a four-way Butler Matrix feed network connected to six arrays of electromagnetic radiating elements, according to another embodiment of the invention.

FIG. 7 illustrates an antenna system including a four-way Butler Matrix feed network connected to seven arrays of electromagnetic radiating elements, according to another embodiment of the invention.

FIG. 8 illustrates an antenna system including a four-way Butler Matrix feed network connected to eight arrays of electromagnetic radiating elements, according to another embodiment of the invention.

### DETAILED DESCRIPTION OF THE INVENTION

The following description discloses various embodiments of switched beam antenna systems including Butler Matrix feed networks and multiple-array antennas configured to create multiple antenna beams. The systems are configured to provide an excellent balance between side lobe suppression and overall gain of the antennas through amplitude tapering among arrays of electromagnetic radiating elements in the antennas. The systems disclosed herein achieve these benefits without affecting the periodicity of the antenna outputs/inputs of the Butler Matrix feed network.

In the following description, reference is made to specific embodiments, components and features. Reference numbers and characters repeated between the various embodiments indicate similar components and features. It should be understood that the use of the word “includes” in the following description is meant to be non-limiting. When the word “includes” is used to describe the inclusion of a component or feature, it should be understood that the specific component described is non-limiting, and there may be other equivalent components or features that fall within the scope of the invention. Alternatively, the inclusion of the component may be optional. It may be appropriate to interpret the word “includes” as meaning “may include,” depending on the context of the discussion.

Furthermore, the description includes various references to “outer”, “central” and “center” arrays (or columns) of electromagnetic radiating elements within antennas. It should be understood that central arrays are arrays located at positions between the outer arrays, and center arrays are central arrays that are positioned at a centermost location of a group of arrays.

Antenna Systems With Three-Way Butler Matrix Feed Networks

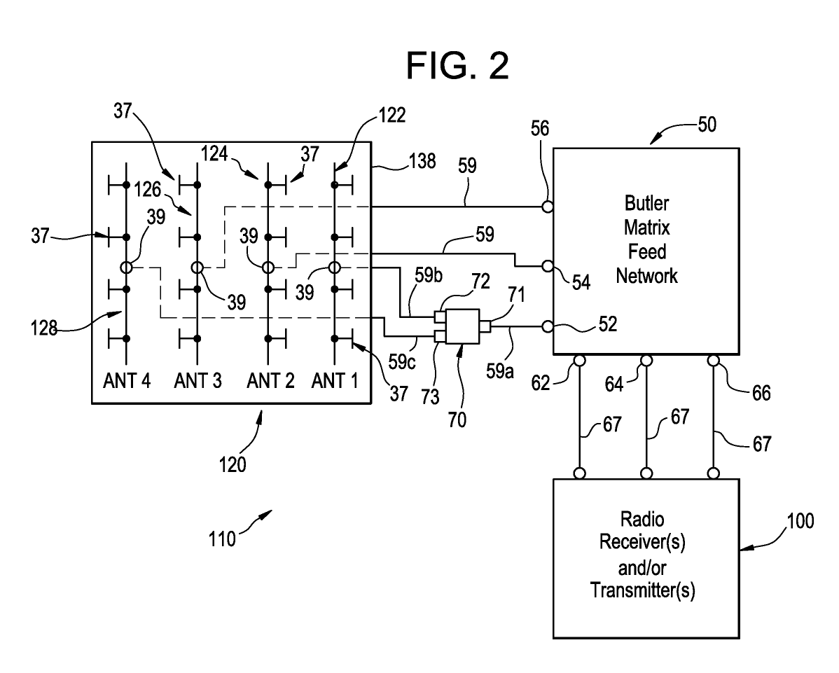

FIGS. 2-4 illustrate exemplary switched beam antenna systems employing three-way Butler Matrix feed networks and amplitude tapering across arrays of antenna radiating elements. In the systems of FIGS. 2-4, four or more actual antenna ports are provided by connecting at least one signal divider/combiner to a Butler Matrix feed network. Power is distributed unequally among the arrays of antenna radiating elements in a manner that provides improved antenna gain and reduced side lobe levels in comparison to conventional switched beam systems employing three-way Butler Matrix feed networks. Generally, power is distributed to the antenna such that power levels taper downwardly from a center array or central arrays towards outer arrays of the antennas.

FIG. 2 illustrates an antenna system 110 according to an embodiment of the invention. As shown in FIG. 2, the system 110 may include a switched beam antenna 120, a three-way Butler Matrix feed network, or phased array feed network 50, and one or more radio receivers and/or radio transmitters 100.

The feed network 50 may be a planar microstrip device with no crossovers, and may be fabricated from a printed circuit board having a dielectric substrate made of low loss ceramic material, for example. However, other the feed network 50 may be of another design and/or construction.

Still referencing FIG. 2, the antenna 120 may include four co-linear arrays (or “columns”) 122, 124, 126, 128 of associated electromagnetic radiating elements 37 positioned with respect to an electrically conductive backplate 138. The co-linear antenna arrays 122, 124, 126, 128 may include a first outer array 122, a first central array 124 adjacent to the first outer array 122, a second central array 126 adjacent to the first central array 124, and a second outer array 128 adjacent to the second central array 126. Said another way, the two central arrays 124, 126 are positioned at a center of the array structure and the two outer arrays 122, 128 are positioned outside of the two central arrays 124, 126. According to a preferred embodiment, each array 122, 124, 126, 128 includes an identical number of radiating elements 37. Although each array 122, 124, 126, 128 is shown as having four radiating elements 37, other numbers of radiating elements are possible. The electromagnetic radiating elements 37 may be dipole radiating elements (“dipoles”) or other types of radiating elements.

As shown in FIG. 2, the feed network 50 may include a first antenna port 52, a second antenna port 54 and a third antenna port 56 configured to communicate with the antenna 120. The feed network 50 may have phase progressions of 0° or ±120° across the three antenna ports 52, 54, 56. The feed network 50 may further include a first receiver/transmitter port 62, a second receiver/transmitter port 64 and a third receiver/transmitter port 66 configured to communicate with the radio receiver(s) and/or radio transmitter(s) 100. The beam generated by the antenna 120 during transmission of RF signals depends upon which receiver/transmitter port 62, 64, 66 is selected.

The first antenna port 52 of the feed network 50 may be connected to the first outer array 122 and the second outer array 128 via a power divider/combiner 70. More specifically, the first antenna port 52 may be connected to a feed network port 71 of the power divider/combiner 70 by a cable 59a, a first antenna port 72 of the power divider/combiner 70 may be connected to the first outer array 122 by a cable 59b and a connector 39, and a second antenna port 73 of the power divider/combiner 70 may be connected to the second outer array 128 by a cable 59c and a connector 39. The second and third antenna ports 54, 56 of the feed network 50 may be connected to the first central array 124 and the second central array 126, respectively, by cables 59 and connectors 39 associated with each array 24, 26. The receiver/transmitter ports 62, 64, 66 of the feed network 50 may be connected to one or more radio receivers and/or radio transmitters 100 by cables 67.

The power divider 70 may be a reciprocal, two-way power divider/combiner for dividing/combining RF signals, for example. The power divider/combiner 70 may be configured to either divide or combine RF signals, depending on whether the antenna is operated for transmission or receipt of RF signals. For the transmission of RF signals, the power divider/combiner 70 may divide an RF signal received from the first antenna port 52 of the feed network 50 into two parts (i.e., each of the parts has a fraction of the original signal strength). For the receipt of RF signals, the power divider/combiner 70 may combine RF signals received from the antenna 120 to provide a combined RF signal to the first antenna port 52 of the feed network 50.

The antenna system 110 may be configured to distribute power unequally among the first and second antenna ports 72, 73 of the power divider/combiner 70 and the second and third antenna ports 54, 56 of the feed network 50. Accordingly, power may be distributed unequally among the arrays 122, 124, 126, 128. More specifically, the power divider/combiner 70 may be configured such that the power at the antenna port 52 of the feed network 50 is split to provide each of the antenna ports 72, 73 of the power divider/combiner 70 about one-half (½) of the power of the first antenna port 52 of the feed network. All of the antenna ports 52, 54, 56 of the feed network 50 may operate at the same power. Therefore, the first outer array 122 and the second outer array 128 of the antenna 120 may operate at about one-half (½) of the power of the first central array 124 and the second central array 126.

Table 1 below provides exemplary power and phase attributes of three beams that may be generated by the antenna system 110.

TABLE 1
Beam Characteristics: 3-Way Butler Matrix
With 4 Antenna Outputs/Inputs

| | Array 122 | Array 124 | Array 126 | Array 128 |
|---|---|---|---|---|
| Beam 1 | −7.8 dB/0° | −4.8 dB/−120° | −4.8 dB/−240° | −7.8 dB/0° |
| (Port 62) | | | | |
| Beam 2 | −7.8 dB/0° | −4.8 dB/0° | −4.8 dB/0° | −7.8 dB/0° |
| (Port 64) | | | | |
| Beam 3 | −7.8 dB/0° | −4.8 dB/+120° | −4.8 dB/+240° | −7.8 dB/0° |
| (Port 66) | | | | |

In the configuration represented in Table 1, the two centermost arrays 124, 126 may each be provided a first amount of power and the two outer arrays 122, 128 may each be provided a second amount of power that is lower than the first amount of power.

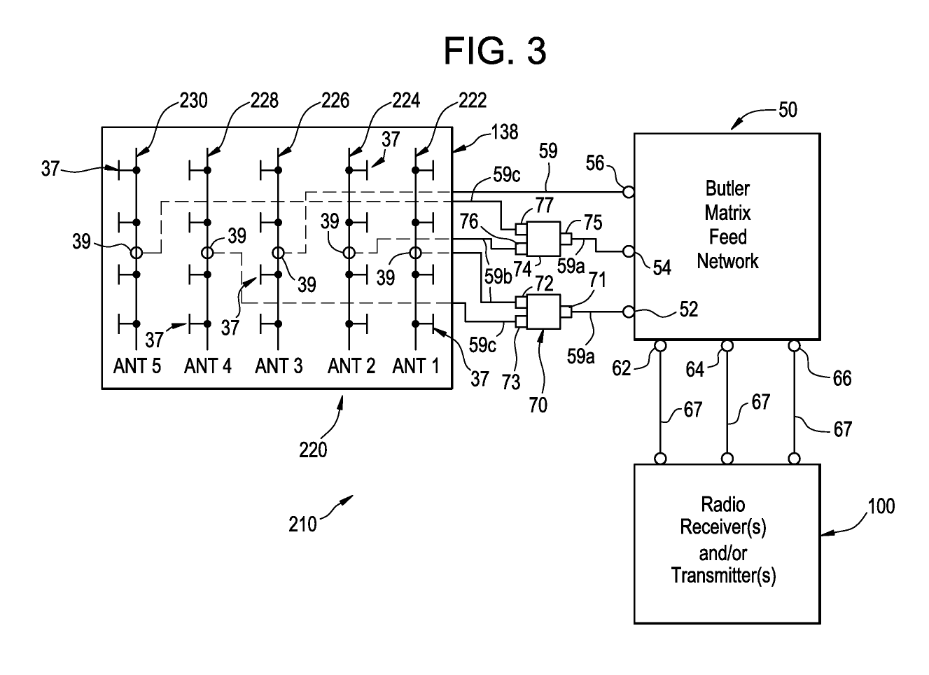

FIG. 3 shows a switched beam antenna system 210 according to another embodiment of the invention. As shown in FIG. 3, the system 210 may include a switched beam antenna 220, the three-way Butler Matrix feed network 50 and one or more radio receivers and/or radio transmitters 100.

Still referring to FIG. 3, the antenna 220 may include five co-linear arrays 222, 224, 226, 228, 230 of associated electromagnetic radiating elements 37 positioned with respect to an electrically conductive backplate 138. The co-linear antenna arrays 222, 224, 226, 228, 230 may include a first outer array 222, a first central array 224 adjacent to the first outer array 222, a center array 226 adjacent to the first central array 224, a second central array 228 adjacent to the center array 226, and a second outer array 230 adjacent to the second central array 228. In other words, the two central arrays 224, 228 are positioned outside of the central array 226 and the two outer arrays 222, 230 are positioned outside of the two central arrays 224, 228. According to a preferred embodiment, each array 222, 224, 226, 228, 230 includes an identical number of radiating elements 37. Although each array 222, 224, 226, 228, 230 is shown as having four radiating elements 37, other numbers of radiating elements are possible.

The first antenna port 52 of the feed network 50 may be connected to the first outer array 222 and the second central array 228 via a first power divider/combiner 70. More specifically, the first antenna port 52 may be connected to a feed network port 71 of the power divider/combiner 70 by a cable 59a, a first antenna port 72 of the power divider/combiner 70 may be connected to the first outer array 222 by a cable 59b and a connector 39, and a second antenna port 73 of the power divider/combiner 70 may be connected to the second central array 228 by a cable 59c and a connector 39.

The second antenna port 54 may be connected to the first central array 224 and the second outer array 230 via a second power divider/combiner 74. More specifically, the second antenna port 54 may be connected to a feed network port 75 of the second power divider/combiner 74 by a cable 59a, a first antenna port 76 of the second power divider/combiner 74 may be connected to the first central array 224 by a cable 59b and a connector 39, and a second antenna port 77 of the second power divider/combiner 74 may be connected to the second outer array 230 by a cable 59c and a connector 39. The second power divider/combiner 74 may be similar to the power divider/combiner 70 with regard to features and functions, as described above with respect to system 110 of FIG. 2.

The third antenna port 56 of the feed network 50 may be connected to the first center array 226 by cables 59 and a connector 39.

For the transmission of RF signals, the power dividers/combiners 70, 74 may divide an RF signal received from the respective antenna port 52, 54 of the feed network 50 into two parts. For the receipt of RF signals, the power dividers/combiners 70, 74 may combine RF signals received from the antenna 220 to provide a combined RF signal to the respective port 52, 54 of the feed network 50.

The system 210 may be configured to distribute power unequally among the first and second antenna ports 72, 73 of the first power divider/combiner 70, the first and second antenna ports 76, 77 of the second power divider/combiner 74 and the third antenna port 56 of the feed network 50. Accordingly, power may be distributed unequally among the arrays 222, 224, 226, 228, 230. More specifically, the first power divider/combiner 70 may be configured such that the power at the antenna port 52 of the feed network 50 is split to provide the first antenna port 72 of the first power divider/combiner 70 about one-third (⅓) of the power of the first antenna port 52 of the feed network 50, and to provide the second antenna port 73 of the first power divider/combiner 70 about two-thirds (⅔) of the power of the first antenna port 52 of the feed network 50. Similarly, the power at the antenna port 54 of the feed network 50 may be split to provide the first antenna port 76 of the second power divider/combiner 74 about two-thirds (⅔) of the power of the first antenna port 54 of the feed network 50, and to provide the second antenna port 77 of the second power divider/combiner 74 about one-third (⅓) of the power of the second antenna port 54 of the feed network 50. All of the antenna ports 52, 54, 56 of the feed network 50 may operate at the same power. Thus, the first and second outer arrays 222, 230 may operate at about one-third (⅓) of the power of the center array 226, and the first and second central arrays 224, 228 may operate at about two-thirds (⅔) of the power of the center array 226.

Table 2 below provides exemplary power and phase attributes of three beams that may be generated by the antenna system 210.

TABLE 2
Beam Characteristics: 3-Way Butler Matrix With 5 Antenna Outputs/Inputs

| | Array 222 | Array 224 | Array 226 | Array 228 | Array 230 |
|---|---|---|---|---|---|
| Beam 1 | −9.5 dB/0° | −6.5 dB/−120° | −4.8 dB/−240° | −6.5 dB/0° | −9.5 dB/−120° |
| (Port 62) | | | | | |
| Beam 2 | −9.5 dB/0° | −6.5 dB/0° | −4.8 dB/0° | −6.5 dB/0° | −9.5 dB/0° |
| (Port 64) | | | | | |
| Beam 3 | −9.5 dB/0° | −6.5 dB/+120° | −4.8 dB/+240° | −6.5 dB/0° | −9.5 dB/+120° |
| (Port 66) | | | | | |

In the configuration depicted in Table 2, the centermost array 226 may be provided a first amount of power, the central arrays 224, 228 may each be provided a second amount of power that is lower than the first amount of power, and the two outer arrays 222, 230 may each be provided a third amount of power that is lower than the second amount of power.

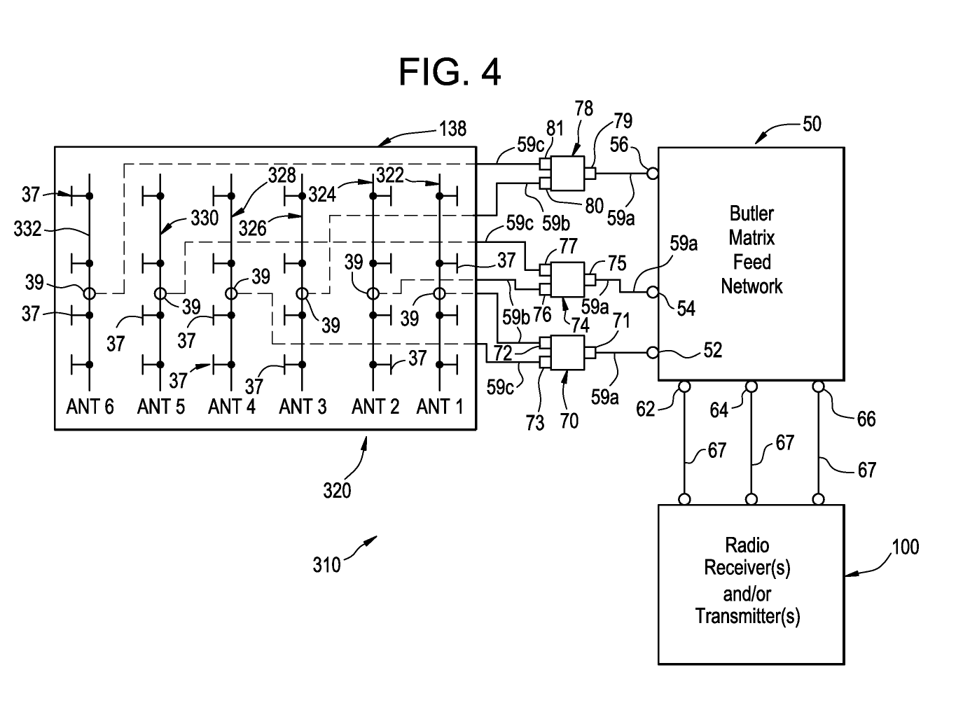

FIG. 4 shows a switched beam antenna system 310 according to another embodiment of the invention. As shown in FIG. 4, the system 310 may include a switched beam antenna 320, the three-way Butler Matrix feed network 50 and one or more radio receivers and/or radio transmitters 100.

Continuing with reference to FIG. 4, the antenna 320 may include six co-linear arrays 322, 324, 326, 328, 330, 332 of associated electromagnetic radiating elements 37 positioned with respect to an electrically conductive backplate 138. The co-linear antenna arrays 322, 324, 326, 328, 330, 332 may include a first outer array 322, a first central array 324 adjacent to the first outer array 322, a second central array 326 adjacent to the first central array 324, a third central array 328 adjacent to the second central array 326, a fourth central array 330 adjacent to the third central array 328, and a second outer array 332 adjacent to the fourth central array 330. In other words, the first and fourth central arrays 324, 330 are positioned outside of the second and third central arrays 326, 328 and the first and second outer arrays 322, 332 are positioned outside of the first and fourth central arrays 324, 330. According to a preferred embodiment, each array 322, 324, 326, 328, 330, 332 includes an identical number of radiating elements 37. Although each array 322, 324, 326, 328, 330, 332 is shown as having four radiating elements 37, other numbers of radiating elements are possible.

The first antenna port 52 of the feed network 50 may be connected to the first outer array 322 and the third central array 328 via a first power divider/combiner 70. More specifically, the first antenna port 52 may be connected to a feed network port 71 of the power divider/combiner 70 by a cable 59a, a first antenna port 72 of the power divider/combiner 70 may be connected to the first outer array 322 by a cable 59b and a connector 39, and a second antenna port 73 of the power divider/combiner 70 may be connected to the third central array 328 by a cable 59c and a connector 39.

The second antenna port 54 may be connected to the first central array 324 and the fourth central array 330 via a second power divider/combiner 74. More specifically, the second antenna port 54 may be connected to a feed network port 75 of the second power divider/combiner 74 by a cable 59a, a first antenna port 76 of the second power divider/combiner 74 may be connected to the first central array 324 by a cable 59b and a connector 39, and a second antenna port 77 of the second power divider/combiner 74 may be connected to the fourth central array 330 by a cable 59c and a connector 39. The second power divider/combiner 74 may be similar to the power divider/combiner 70 with regard to features and functions, as described above with respect to system 110 of FIG. 2.

The third antenna port 56 of the feed network 50 may be connected to the second central array 326 and the second outer array 332 via a third power divider/combiner 78. Particularly, the third antenna port 56 may be connected to a feed network port 79 of the third power divider/combiner 78 by a cable 59a, a first antenna port 80 of the third power divider/combiner 78 may be connected to the second central array 326 by a cable 59b and a connector 39, and a second antenna port 81 of the third power divider/combiner 78 may be connected to the second outer array 332 by a cable 59c and a connector 39. The third power divider/combiner 78 may be similar to the power divider/combiner 70 with regard to features and functions, as described above with respect to system 110 of FIG. 2.

For the transmission of RF signals, the power dividers/combiners 70, 74, 78 may divide an RF signal received from the respective antenna port 52, 54, 56 of the feed network 50 into two parts. For the receipt of RF signals, the power dividers/combiners 70, 74, 78 may combine RF signals received from the antenna 320 to provide a combined RF signal to the respective port 52, 54, 56 of the feed network 50.

The system 310 may be configured to distribute power unequally among the first and second antenna ports 72, 73 of the first power divider/combiner 70, the first and second antenna ports 76, 77 of the second power divider/combiner 74, and the first and second antenna ports 80, 81 of the third power divider/combiner 78. Accordingly, power may be distributed unequally among the arrays 322, 324, 326, 328, 330, 332. More specifically, the first power divider/combiner 70 may be configured such that the power at the first antenna port 52 of the feed network 50 is split to provide the first antenna port 72 of the first power divider/combiner 70 about one-seventh ( 1/7) of the power of the first antenna port 52 of the feed network 50, and to provide the second antenna port 73 of the first power divider/combiner 70 about six-sevenths ( 6/7) of the power of the first antenna port 52 of the feed network 50. The power at the second antenna port 54 of the feed network 50 may be split to provide each antenna port 76, 77 of the second power divider/combiner 74 about one-half (½) of the power of the second antenna port 54 of the feed network 50. The power at the third antenna port 56 of the feed network 50 may be split to provide the first antenna port 80 of the third power divider/combiner 78 about six-sevenths ( 6/7) of the power of the third antenna port 56 of the feed network 50, and to provide the second antenna port 81 of the third power divider/combiner 78 about one-seventh ( 1/7) of the power of the third antenna port 56 of the feed network 50. All of the antenna ports 52, 54, 56 of the feed network 50 may operate at the same power. Accordingly, the first and second outer arrays 322, 332 may operate at about one-sixth (⅙) of the power of the second and third central arrays 326, 328, and the first and fourth central arrays 324, 330 may operate at about seven-twelfths ( 7/12) of the power of the second and third central arrays 326, 328.

Table 3 below provides beam exemplary power and phase attributes of three beams that may be generated by the antenna system 310.

TABLE 3
Beam Characteristics: 3-Way Butler Matrix With 6 Antenna Outputs/Inputs

| | Array 322 | Array 324 | Array 326 | Array 328 | Array 330 | Array 332 |
|---|---|---|---|---|---|---|
| Beam 1 | −13.2 dB/0° | −7.8 dB/−120° | −5.4 dB/−240° | −5.4 dB/0° | −7.8 dB/−120° | −13.2 dB/−240° |
| (Port 62) | | | | | | |
| Beam 2 | −13.2 dB/0° | −7.8 dB/0° | −5.4 dB/0° | −5.4 dB/0° | −7.8 dB/0° | −13.2 dB/0° |
| (Port 64) | | | | | | |
| Beam 3 | −13.2 dB/0° | −7.8 dB/+120° | −5.4 dB/+240° | −5.4 dB/0° | −7.8 dB/+120° | −13.2 B/+240° |
| (Port 66) | | | | | | |

In the configuration depicted in Table 3, the second and third central arrays 326, 328 may each be provided a first amount of power, the first and fourth central arrays 324, 330 may each be provided a second amount of power that is lower than the first amount of power, and the two outer arrays 322, 332 may each be provided a third amount of power that is lower than the second amount of power.

In comparison with a conventional six-way Butler Matrix feed network with paired inputs that generates three beams, the embodiment of FIG. 4 can provide the same number of beams, but with a 0.5 dB greater gain and deeper pattern crossovers. Additionally, this embodiment is easier to construct and implement than a six-way Butler Matrix feed network.

The embodiments of FIGS. 2-4 are merely a few examples of antenna systems that split the antenna ports of a three-way Butler Matrix feed network. In a three-beam antenna system with a ±0° or ±120° phase progression across the antenna arrays, any number of antenna arrays can be fed by splitting the power of the antenna ports 52, 54, 56 of the feed network and dividing the power unequally among the arrays to achieve the amplitude taper needed for side lobe suppression.

Antenna Systems With Four-Way Butler Matrix Feed Networks

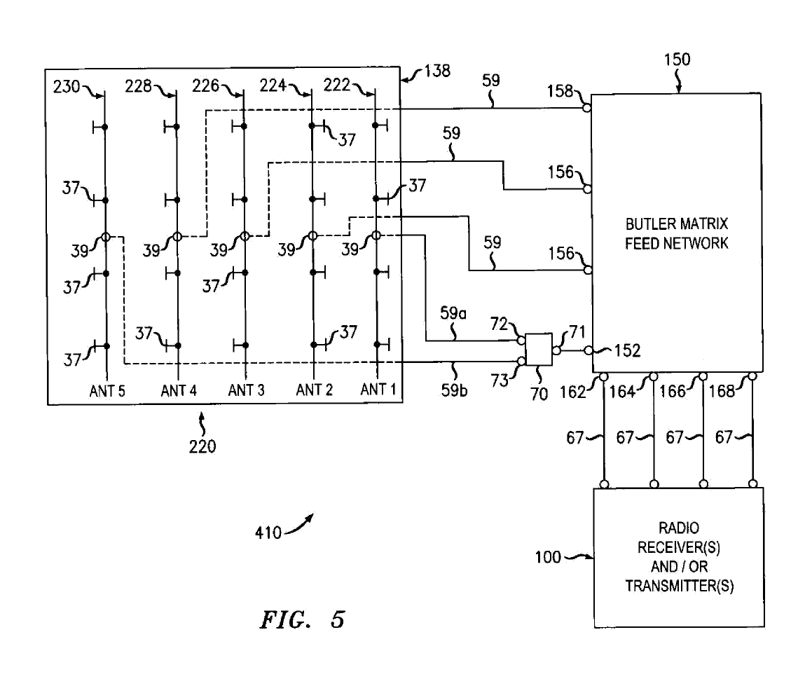

FIGS. 5-8 illustrate exemplary switched beam antenna systems employing four-way Butler Matrix feed networks and amplitude tapering across arrays of antenna radiating elements. In the systems of FIGS. 5-8, five or more actual antenna ports are provided by connecting at least one signal divider/combiner to a Butler Matrix feed network. Power is distributed unequally among the arrays of antenna radiating elements in a manner that provides improved antenna gain and reduced side lobe levels in comparison to conventional switched beam systems employing four-way Butler Matrix feed networks. In general, power is distributed to the antenna such that power levels taper downwardly from a center array or central arrays towards outer arrays of the antennas.

FIG. 5 illustrates an antenna system 410 according to an embodiment of the invention. As shown in FIG. 5, the system 410 may include a switched beam antenna 220 as described above with respect to the embodiment of FIG. 3, a four-way Butler Matrix feed network 150 and one or more radio receivers and/or radio transmitters 100. The feed network 150 may be similar to the feed network 50 in the embodiments of FIGS. 2-4, except that the feed network 150 includes four antenna ports 152, 154, 156, 158 and four receiver/transmitter ports 162, 164, 166, 168.

Still referring to FIG. 5, the feed network 150 may include a first antenna port 152, a second antenna port 154, a third antenna port 156 and a fourth antenna port 158 configured to communicate with the antenna 220. The feed network 150 may have phase progressions of ±45° or ±135° across the four antenna ports 52, 54, 56. The feed network 150 may further include a first receiver/transmitter port 162, a second receiver/transmitter port 164, a third receiver/transmitter port 166 and a fourth receiver/transmitter port 168 configured to communicate with the radio receiver(s) and/or radio transmitter(s) 100. The beam generated by the antenna 220 during transmission of RF signals depends upon which receiver/transmitter port 162, 164, 166, 168 is selected.

The first antenna port 152 of the feed network 150 may be connected to the first outer array 222 and the second outer array 230 via a power divider/combiner 70. More specifically, the first antenna port 152 may be connected to a feed network port 71 of the power divider/combiner 70 by a cable 59a, a first antenna port 72 of the power divider/combiner 70 may be connected to the first outer array 222 by a cable 59b and a connector 39, and a second antenna port 73 of the power divider/combiner 70 may be connected to the second outer array 230 by a cable 59c and a connector 39. The second, third and fourth antenna ports 154, 156, 158 of the feed network 150 may be connected to the first central array 224, the center array 226 and the second central array 228, respectively, by cables 59 and connectors 39 associated with each array 224, 226, 228. The receiver/transmitter ports 162, 164, 166 of the feed network 150 may be connected to one or more radio receivers and/or radio transmitters 100 by cables 67.

For the transmission of RF signals, the power divider/combiner 70 may divide an RF signal received from the first antenna port 152 of the feed network 150 into two parts. For the receipt of RF signals, the power divider/combiner 70 may combine RF signals received from the antenna 220 to provide a combined RF signal to the first antenna port 152 of the feed network 150.

Power may be distributed unequally among the first and second antenna ports 72, 73 of the power divider/combiner 70 and the second, third and fourth antenna ports 154, 156, 158 of the feed network 150. Therefore, power may be distributed unequally among the arrays 222, 224, 226, 228, 230. More specifically, the power divider/combiner 70 may be configured such that the power at the antenna port 152 of the feed network 150 is split to provide each of the antenna ports 72, 73 of the power divider/combiner 70 about one-half (½) of the power of the first antenna port 152 of the feed network with a 180° phase shift at the antenna port 73. All of the antenna ports 152, 154, 156, 158 of the feed network 150 may operate at the same power. Thus, the first outer array 222 and the second outer array 230 of the antenna 220 may operate at about one-half (½) of the power of the first central array 224, the center array 226 and the second central array 228, with the second outer array 230 having a 180° phase shift with respect to the first outer array 222.

Table 4 below provides exemplary power and phase attributes of four beams that may be generated by the antenna system 410.

TABLE 4
Beam Characteristics: 4-Way Butler Matrix With 5 Antenna Outputs/Inputs

| | Array 222 | Array 224 | Array 226 | Array 228 | Array 230 |
|---|---|---|---|---|---|
| Beam 1 | −9.0 dB/0° | −6.0 dB/−135° | −6.0 dB/−270° | −6.0 dB/−405° (−45°) | −9.0 dB/−540° (+180°) |
| (Port 62) | | | | | |
| Beam 2 | −9.0 dB/0° | −6.0 dB/−45° | −6.0 dB/−90° | −6.0 dB/−135° | −9.0 dB/−180° |
| (Port 64) | | | | | |
| Beam 3 | −9.0 dB/0° | −6.0 dB/+45° | −6.0 dB/+90° | −6.0 dB/+135° | −9.0 dB/+180° |
| (Port 66) | | | | | |
| Beam 4 | −9.0 dB/0° | −6.0 dB/+135° | −6.0 dB/+270° | −6.0 dB/+405° (+45°) | −9.0 dB/+540° (−180°) |
| (Port 68) | | | | | |

In the configuration depicted in Table 4, the centermost array 226 and the central arrays 224, 228 may each be provided a first amount of power, and the two outer arrays 222, 230 may each be provided a second amount of power that is lower than the first amount of power.

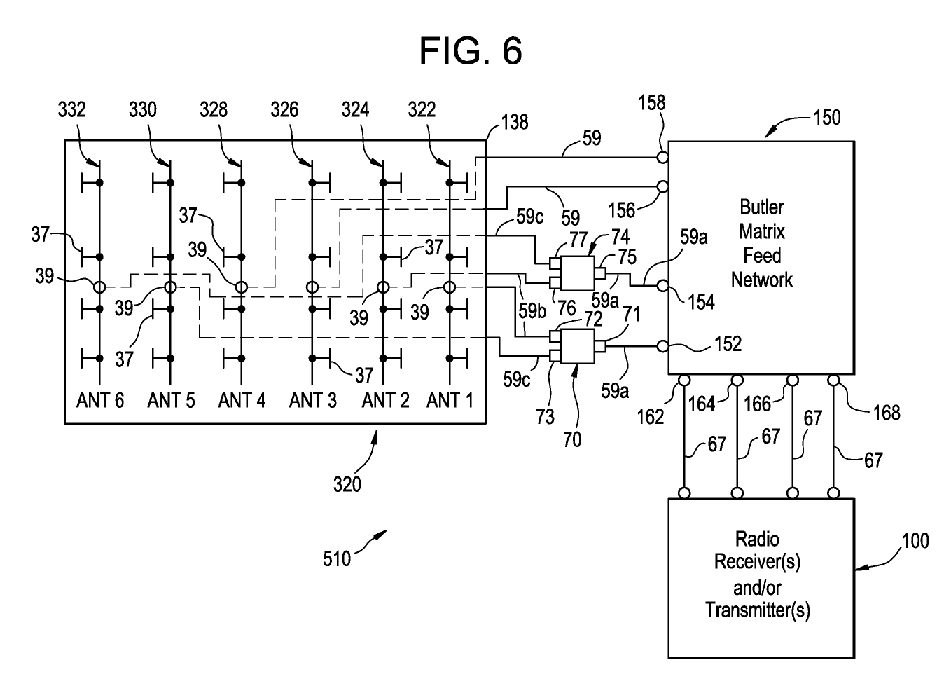

FIG. 6 shows a switched beam antenna system 510 according to another embodiment of the invention. As illustrated in FIG. 6, the system 510 may include the antenna 320 as described above with respect to the embodiment of FIG. 4, the four-way Butler Matrix feed network 150 and one or more radio receivers and/or radio transmitters 100.

Still referring to FIG. 6, the first antenna port 152 of the feed network 150 may be connected to the first outer array 322 and the fourth central array 330 via a first power divider/combiner 70. Particularly, the first antenna port 152 may be connected to a feed network port 71 of the power divider/combiner 70 by a cable 59a, a first antenna port 72 of the first power divider/combiner 70 may be connected to the first outer array 322 by a cable 59b and a connector 39, and a second antenna port 73 of the power divider/combiner 70 may be connected to the fourth central array 330 by a cable 59c and a connector 39.

The second antenna port 154 may be connected to the first central array 324 and the second outer array 332 via a second power divider/combiner 74. More specifically, the second antenna port 154 may be connected to a feed network port 75 of the second power divider/combiner 74 by a cable 59a, a first antenna port 76 of the second power divider/combiner 74 may be connected to the first central array 324 by a cable 59b and a connector 39, and a second antenna port 77 of the second power divider/combiner 74 may be connected to the second outer array 332 by a cable 59c and a connector 39.

The third and fourth antenna ports 156, 158 of the feed network 150 may be connected to the second central array 326 and the third central array 328, respectively, by a cable 59 and a connector 39 associated with each array 326, 328.

For the transmission of RF signals, the power dividers/combiners 70, 74 may divide an RF signal received from the respective antenna port 152, 154 of the feed network 150 into two parts. For the receipt of RF signals, the power dividers/combiners 70, 74 may combine RF signals received from the antenna 320 to provide a combined RF signal to the respective port 152, 154 of the feed network 150.

The system 510 may be configured to distribute power unequally among the first and second antenna ports 72, 73 of the first power divider/combiner 70, the first and second antenna ports 76, 77 of the second power divider/combiner 74 and the third and fourth antenna ports 156, 158 of the feed network 150. Thus, power may be distributed unequally among the arrays 322, 324, 326, 328, 330, 332. More specifically, the first power divider/combiner 70 may be configured such that the power at the first antenna port 152 of the feed network 150 is split to provide the first antenna port 72 of the first power divider/combiner 70 about one-third (⅓) of the power of the first antenna port 152 of the feed network 150, and to provide the second antenna port 73 of the first power divider/combiner 70 about two-thirds (⅔) of the power of the first antenna port 152 of the feed network 150 with a 180° phase shift. The power at the second antenna port 154 of the feed network 150 may be split to provide the first antenna port 76 of the second power divider/combiner 74 about two-thirds (⅔) of the power of the second antenna port 154 of the feed network 150, and to provide the second antenna port 77 of the second power divider/combiner 74 about one-third (⅓) of the power of the second antenna port 154 of the feed network 150 with a 180° phase shift. All of the antenna ports 152, 154, 156, 158 of the feed network 150 may operate at the same power. Therefore, the first and second outer arrays 322, 332 may operate at about one-third (⅓) of the power of the second and third central arrays 326, 328, while the first and fourth central arrays 324, 330 may operate at about two-thirds (⅔) of the power of the second and third central arrays 326, 328. A 180° phase shift may be provided between the first outer array 322 and the fourth central array 330, and between the first central array 324 and the second outer array 332.

The following Table 5 provides exemplary power and phase attributes of four beams that may be generated by the antenna system 510.

TABLE 5
Beam Characteristics: 4-Way Butler Matrix With 6 Antenna Outputs/Inputs

| | Array 322 | Array 324 | Array 326 | Array 328 | Array 330 | Array 332 |
|---|---|---|---|---|---|---|
| Beam 1 | −10.8 dB/0° | −7.8 dB/−135° | −6.0 dB/−270° | −6.0 dB/−405° | −7.8 dB/−540° | −10.8 dB/−675° |
| (Port 62) | | | | (−45°) | (+180°) | (−315°) |
| Beam 2 | −10.8 dB/0° | −7.8 dB/−45° | −6.0 dB/−90° | −6.0 dB/−135° | −7.8 dB/−180° | −10.8 dB/−225° |
| (Port 64) | | | | | | |
| Beam 3 | −10.8 dB/0° | −7.8 dB/+45° | −6.0 dB/+90° | −6.0 dB/+135° | −7.8 dB/+180° | −10.8 dB/+225° |
| (Port 66) | | | | | | |
| Beam 4 | −10.8 dB/0° | −7.8 dB/+135° | −6.0 dB/+270° | −6.0 dB/+405° | −7.8 dB/+540° | −10.8 dB/+675° |
| (Port 68) | | | | (+45°) | (−180°) | (+315°) |

In the configuration depicted in Table 5, the second and third central arrays 326, 328 may each be provided a first amount of power, the first and fourth central arrays 324, 330 may each be provided a second amount of power that is lower than the first amount of power, and the two outer arrays 322, 332 may each be provided a third amount of power that is lower than the second amount of power.

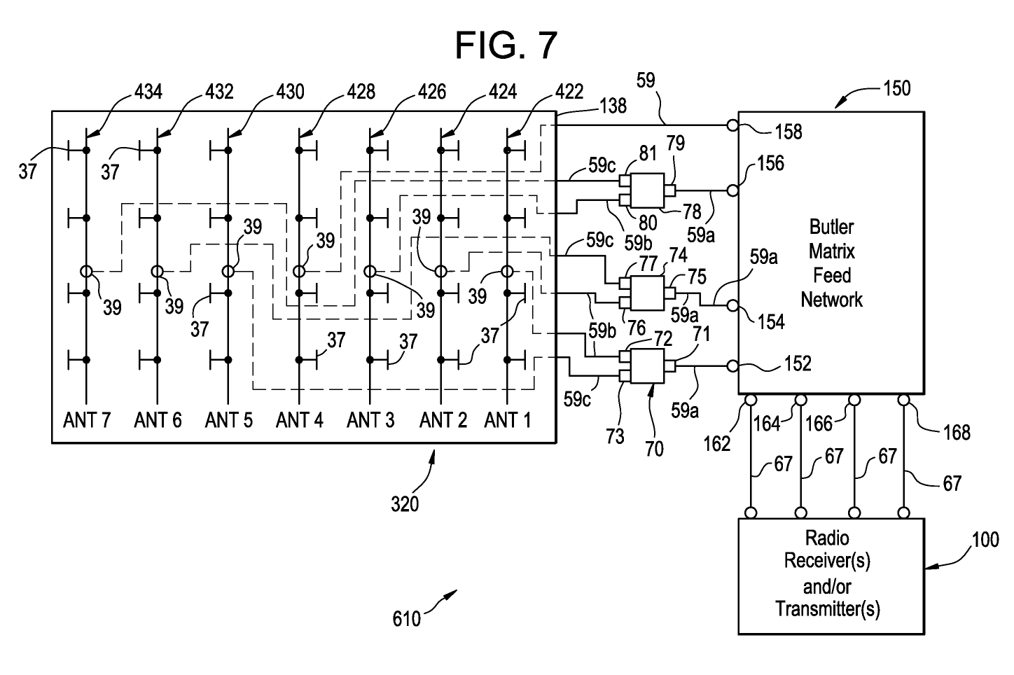

FIG. 7 shows a switched beam antenna system 610 according to yet another embodiment of the invention. As shown in FIG. 7, the system 610 may include a switched beam antenna 420, the four-way Butler Matrix feed network 150 and one or more radio receivers and/or radio transmitters 100.

Continuing with reference to FIG. 7, the antenna 420 may include seven co-linear arrays 422, 424, 426, 428, 430, 432, 434 of associated electromagnetic radiating elements 37 positioned with respect to an electrically conductive backplate 138. The co-linear antenna arrays 422, 424, 426, 428, 430, 432, 434 may include a first outer array 422, a first central array 424 adjacent to the first outer array 422, a second central array 426 adjacent to the first central array 424, a center array 428 adjacent to the second central array 426, a third central array 430 adjacent to the center array 428, a fourth central array 432 adjacent to the third central array 430, and a second outer array 434 adjacent to the fourth central array 432. Stated another way, the second and third central arrays 426, 430 are positioned outside of the center array 428, the first and fourth central arrays 424, 432 are positioned outside of the second and third central arrays 426, 430 and the first and second outer arrays 422, 434 are positioned outside of the first and fourth central arrays 422, 434. According to a preferred embodiment, each array 422, 424, 426, 428, 430, 432, 434 includes an identical number of radiating elements 37. Although each array 422, 424, 426, 428, 430, 432, 434 is shown as having four radiating elements 37, other numbers of radiating elements are possible.

The first antenna port 152 of the feed network 150 may be connected to the first outer array 422 and the third central array 430 through a power divider/combiner 70. More specifically, the first antenna port 152 may be connected to a feed network port 71 of the power divider/combiner 70 by a cable 59a, a first antenna port 72 of the power divider/combiner 70 may be connected to the first outer array 422 by a cable 59b and a connector 39, and a second antenna port 73 of the power divider/combiner 70 may be connected to the third central array 430 by a cable 59c and a connector 39.

The second antenna port 154 of the feed network 150 may be connected to the first central array 424 and the fourth central array 432 through a second power divider/combiner 74. To be more specific, the second antenna port 154 of the feed network 150 may be connected to a feed network port 75 of the second power divider/combiner 74 by a cable 59a, a first antenna port 76 of the second power divider/combiner 74 may be connected to the first central array 424 by a cable 59b and a connector 39, and a second antenna port 77 of the second power divider/combiner 74 may be connected to the fourth central array 432 by a cable 59c and a connector 39.

The third antenna port 156 of the feed network 150 may be connected to the second central array 426 and the second outer array 434 through a third power divider/combiner 78. Particularly, the third antenna port 156 of the feed network 150 may be connected to a feed network port 79 of the third power divider/combiner 78 by a cable 59a, a first antenna port 80 of the third power divider/combiner 78 may be connected to the second central array 426 by a cable 59b and a connector 39, and a second antenna port 81 of the third power divider/combiner 78 may be connected to the second outer array 434 by a cable 59c and a connector 39.

The fourth antenna port 158 of the feed network 150 may be connected to the center array 428 by a cable 59 and a connector 39.

For the transmission of RF signals, the power dividers/combiners 70, 74, 78 may divide an RF signal received from the respective antenna port 152, 154, 156 of the feed network 150 into two parts. For the receipt of RF signals, the power dividers/combiners 70, 74, 78 may combine RF signals received from the antenna 420 to provide a combined RF signal to the respective port 152, 154, 156 of the feed network 150.

Power may be distributed unequally among the first and second antenna ports 72, 73 of the first power divider/combiner 70, the first and second antenna ports 76, 77 of the second power divider/combiner 74, the first and second antenna ports 80, 81 of the third power divider/combiner 78 and the fourth antenna port 158 of the feed network 150. Therefore, power may be distributed unequally among the arrays 422, 424, 426, 428, 430, 432, 434. More particularly, the first power divider/combiner 70 may be configured such that the power at the first antenna port 152 of the feed network 150 is split to provide the first antenna port 72 of the first power divider/combiner 70 about one-fourth (¼) of the power of the first antenna port 152 of the feed network 150, and to provide the second antenna port 73 of the first power divider/combiner 70 about three-fourths (¾) of the power of the first antenna port 152 of the feed network 150 with a 180° phase shift. The power at the second antenna port 154 of the feed network 150 may be split to provide each of the first and second antenna ports 76, 77 of the second power divider/combiner 74 about one-half (½) of the power of the second antenna port 154 of the feed network 150, with a 180° phase shift at the second antenna port 77 of the second power divider/combiner 74. The power at the third antenna port 156 of the feed network 150 may be split to provide the first antenna port 80 of the third power divider/combiner 78 about three-fourths (¾) of the power of the third antenna port 156 of the feed network 150, and to provide the second antenna port 81 of the third power divider/combiner 78 about one-fourth (¼) of the power of the third antenna port 156 of the power divider/combiner 78 with a 180° phase shift. All of the antenna ports 152, 154, 156, 158 of the feed network 150 may operate at the same power. Thus, the first and second outer arrays 422, 434 may operate at about one-fourth (¼) of the power of the second and center array 428, the first and fourth central arrays 424, 432 may operate at about one-half (½) of the power of the center array 428, and the second and third central arrays 426, 430 may operate at about three-fourths (¾) of the power of the center array 428. A 180° phase shift may be provided between the first outer array 422 and the third central array 430, between the first central array 424 and the fourth central array 434, and between the second central array 426 and the second outer array 434.

The following Table 6 provides exemplary power and phase attributes of four beams that may be generated by the antenna system 610.

TABLE 6
Beam Characteristics: 4-Way Butler Matrix With 7 Antenna Outputs/Inputs

| | Array 422 | Array 424 | Array 426 | Array 428 | Array 430 | Array 432 | Array 434 |
|---|---|---|---|---|---|---|---|
| Beam 1 | −12.0 dB/0° | −9.0 dB/−135° | −7.3 dB/−270° | −6.0 dB/−405° | −7.3 dB/−540° | −9.0 dB/−675° | −12.0 dB/−810° |
| (Port 62) | | | | (−45°) | (+180°) | (−315°) | (−90°) |
| Beam 2 | −12.0 dB/0° | −9.0 dB/−45° | −7.3 dB/−90° | −6.0 dB/−135° | −7.3 dB/−180° | −9.0 dB/−225° | −12.0 dB/−270° |
| (Port 64) | | | | | | | |
| Beam 3 | −12.0 dB/0° | −9.0 dB/+45° | −7.3 dB/+90° | −6.0 dB/+135° | −7.3 dB/+180° | −9.0 dB/+225° | −12.0 dB/+270° |
| (Port 66) | | | | | | | |
| Beam 4 | −12.0 dB/0° | −9.0 dB/+135° | −7.3 dB/+270° | −6.0 dB/+405° | −7.3 dB/+540° | −9.0 dB/+675° | −12.0 dB/+810° |
| (Port 68) | | | | (+45°) | (−180°) | (+315°) | (−90°) |

In the configuration represented in Table 6, the centermost array 428 may be provided a first amount of power, the second and third central arrays 426, 430 may each be provided a second amount of power that is lower than the first amount of power, the first and fourth central arrays 424, 432 may each be provided a third amount of power that is lower than the second amount of power, and the first and second outer arrays 422, 434 may each be provided a fourth amount of power that is lower than the third amount of power.

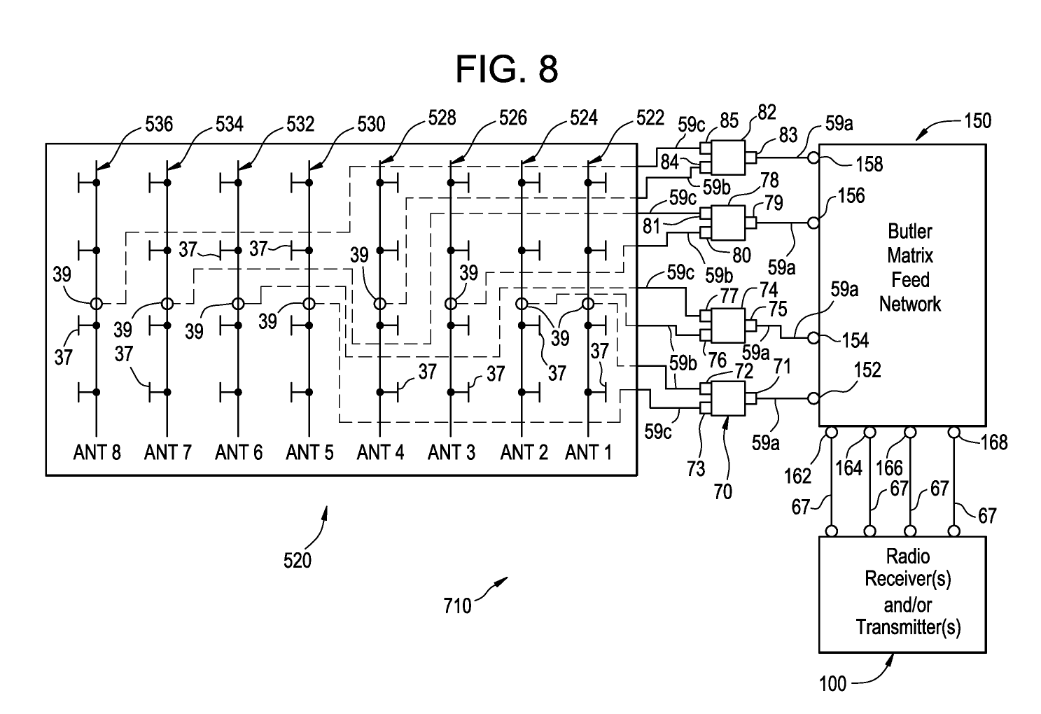

FIG. 8 shows a switched beam antenna system 710 according to yet another embodiment of the invention. As shown in FIG. 8, the system 710 may include a switched beam antenna 520, the four-way Butler Matrix feed network 150 and one or more radio receivers and/or radio transmitters 100.

Still referring to FIG. 8, the antenna 520 may include eight co-linear arrays 522, 524, 526, 528, 530, 532, 534, 536 of associated electromagnetic radiating elements 37 positioned with respect to an electrically conductive backplate 138. The co-linear antenna arrays 522, 524, 526, 528, 530, 532, 534, 536 may include a first outer array 522, a first central array 524 adjacent to the first outer array 522, a second central array 526 adjacent to the first central array 524, a third central array 528 adjacent to the second central array 526, a fourth central array 530 adjacent to the third central array 528, a fifth central array 532 adjacent to the fourth central array 530, a sixth central array 534 adjacent to the fifth central array 532 and a second outer array 536 adjacent to the sixth central array 534. According to a preferred embodiment, each array 522, 524, 526, 528, 530, 532, 534, 536 includes an identical number of radiating elements 37. Although each array 522, 524, 526, 528, 530, 532, 534, 536 is shown as having four radiating elements 37, other numbers of radiating elements are possible.

The first antenna port 152 of the feed network 150 may be connected to the first outer array 522 and the fourth central array 530 through a power divider/combiner 70. More specifically, the first antenna port 152 may be connected to a feed network port 71 of the power divider/combiner 70 by a cable 59a, a first antenna port 72 of the power divider/combiner 70 may be connected to the first outer array 522 by a cable 59b and a connector 39, and a second antenna port 73 of the power divider/combiner 70 may be connected to the fourth central array 530 by a cable 59c and a connector 39.

The second antenna port 154 of the feed network 150 may be connected to the first central array 524 and the fifth central array 532 through a second power divider/combiner 74. To be more specific, the second antenna port 154 of the feed network 150 may be connected to a feed network port 75 of the second power divider/combiner 74 by a cable 59a, a first antenna port 76 of the second power divider/combiner 74 may be connected to the first central array 524 by a cable 59b and a connector 39, and a second antenna port 77 of the second power divider/combiner 74 may be connected to the fifth central array 532 by a cable 59c and a connector 39.

The third antenna port 156 of the feed network 150 may be connected to the second central array 526 and the sixth central array 534 through a third power divider/combiner 78. Particularly, the third antenna port 156 of the feed network 150 may be connected to a feed network port 79 of the third power divider/combiner 78 by a cable 59a, a first antenna port 80 of the third power divider/combiner 78 may be connected to the second central array 526 by a cable 59b and a connector 39, and a second antenna port 81 of the third power divider/combiner 78 may be connected to the sixth central array 534 by a cable 59c and a connector 39.

The fourth antenna port 158 of the feed network 150 may be connected to the third central array 528 and the second outer array 536 through a fourth power divider/combiner 82. More specifically, the fourth antenna port 158 of the feed network 150 may be connected to a feed network port 83 of the fourth power divider/combiner 82 by a cable 59a, a first antenna port 84 of the fourth power divider/combiner 82 may be connected to the third central array 528 by a cable 59b and a connector 39, and a second antenna port 85 of the fourth power divider/combiner 82 may be connected to the second outer array 536 by a cable 59c and a connector 39.

For the transmission of RF signals, the power dividers/combiners 70, 74, 78, 82 may divide an RF signal received from the respective antenna port 152, 154, 156, 158 of the feed network 150 into two parts. For the receipt of RF signals, the power dividers/combiners 70, 74, 78, 82 may combine RF signals received from the antenna 520 to provide a combined RF signal to the respective port 152, 154, 156, 158 of the feed network 150.

Power may be distributed unequally among the first and second antenna ports 72, 73 of the first power divider/combiner 70, the first and second antenna ports 76, 77 of the second power divider/combiner 74, the first and second antenna ports 80, 81 of the third power divider/combiner 78, and the first and second antenna ports 84, 85 of the fourth power divider/combiner 82. Therefore, power may be distributed unequally among the arrays 522, 524, 526, 528, 530, 532, 534, 536. More particularly, the first power divider/combiner 70 may be configured such that the power at the first antenna port 152 of the feed network 150 is split to provide the first antenna port 72 of the first power divider/combiner 70 about one-seventh ( 1/7) of the power of the first antenna port 152 of the feed network 150, and to provide the second antenna port 73 of the first power divider/combiner 70 about six-sevenths ( 6/7) of the power of the first antenna port 152 of the feed network 150 with a 180° phase shift. The power at the second antenna port 154 of the feed network 150 may be split to provide the first antenna port 76 of the second power divider/combiner 74 about one-third (⅓) of the power of the second antenna port 154 of the feed network 150, and to provide the second antenna port 77 of the second power divider/combiner 74 about two-thirds (⅔) of the power of the second antenna port 154 of the feed network 150 with a 180° phase shift. The power at the third antenna port 156 of the feed network 150 may be split to provide the first antenna port 80 of the third power divider/combiner 78 about two-thirds (⅔) of the power of the third antenna port 156 of the feed network 150, and to provide the second antenna port 81 of the third power divider/combiner 78 about one-third (⅓) of the power of the third antenna port 156 of the feed network 150 with a 180° phase shift. The power at the fourth antenna port 158 of the feed network 150 may be split such that the first antenna port 84 of the fourth power divider/combiner 82 is provided about six-sevenths ( 6/7) of the power of the fourth antenna port 158 of the feed network 150, and the second antenna port 85 of the fourth power divider/combiner 82 is provided about one-seventh ( 1/7) of the power of the fourth antenna port 158 of the feed network 150 with a 180° phase shift. All of the antenna ports 152, 154, 156, 158 of the feed network 150 may operate at the same power. Thus, the first and second outer arrays 522, 536 may operate at about one-sixth (⅙) of the power of the third and fourth central arrays 528, 530. The first and sixth central arrays 524, 534 may operate at about seven-eighteenths ( 7/18) of the power of the third and fourth central arrays 528, 530. The second and fifth central arrays 526, 532 may operate at about seven-ninths ( 7/9) of the power of the third and fourth central arrays 528, 530. A 180° phase shift may be provided between the first outer array 522 and the fourth central array 530, between the first central array 524 and the fifth central array 532, between the second central array 526 and the sixth central array 534, and between the fourth central array 528 and the second outer array 536.

The following Table 7 provides exemplary power and phase attributes of four beams that may be generated by the antenna system 710.

TABLE 7
Beam Characteristics: 4-Way Butler Matrix With 8 Antenna Outputs/Inputs

| | Array 522 | Array 524 | Array 526 | Array 528 | Array 530 | Array 532 | Array 534 | Array 536 |
|---|---|---|---|---|---|---|---|---|
| Beam 1 | −14.5 dB/0° | −10.8 dB/−135° | −7.8 dB/−270° | −6.7 dB/−405° | −6.7 dB/−540° | −7.8 dB/−675° | −10.8 dB/−810° | −14.5 dB/−945° |
| (Port 62) | | | | (−45°) | (+180°) | (−315°) | (−90°) | (−225°) |
| Beam 2 | −14.5 dB/0° | −10.8 dB/−45° | −7.8 dB/−90° | −6.7 dB/−135° | −6.7 dB/−180° | −7.8 dB/−225° | −10.8 dB/−270° | −14.5 dB/−315° |
| (Port 64) | | | | | | | | |
| Beam 3 | −14.5 dB/0° | −10.8 dB/+45° | −7.8 dB/+90° | −6.7 dB/+135° | −6.7 dB/+180° | −7.8 dB/+225° | −10.8 dB/+270° | −14.5 dB/+315° |
| (Port 66) | | | | | | | | |
| Beam 4 | −14.5 dB/0° | −10.8 dB/+135° | −7.8 dB/+270° | −6.7 dB/+405° | −6.7 dB/+540° | −7.8 dB/+675° | −10.8 dB/+810° | −14.5 dB/+945° |
| (Port 68) | | | | (+45°) | (−180°) | (+315°) | (−90°) | (+225°) |

In the configuration of Table 7, the third and fourth central arrays 528, 530 may each be provided a first amount of power, the second and fifth central arrays 526, 532 may each be provided a second amount of power that is lower than the first amount of power, the first and sixth central arrays 524, 534 may each be provided a third amount of power that is lower than the second amount of power, and the first and second outer arrays 522, 536 may each be provided a fourth amount of power that is lower than the third amount of power.

It can be seen from the phases provided in Table 7 that the antenna ports 72, 73, 76 and 77 are 180° out of phase with the antenna ports 80, 81, 84 and 85, respectively. If the antenna ports 152, 154, 156, 158 of the feed network 150 were split further by using three-way power dividers/combiners in place of the two-way power dividers/combiners described herein, four additional antenna ports would be provided at the power dividers/combiners, the antenna ports 72, 76, 80, 84 would be 180° out of phase with the four antenna ports 73, 77, 81, 85 and the new antenna ports provided by the three-way power dividers/combiners would be in-phase with antenna ports 72, 76, 80, 84, respectively. According to the invention, in a four-beam antenna system with a ±45° or ±135° phase progression across the antenna arrays, any number of antenna arrays can be fed by splitting the power of the antenna ports 152, 154, 156, 158 of the feed network 150 and dividing the power unequally among the arrays so that the amplitude taper needed for side lobe suppression can be achieved.

Furthermore, it may be desired to use a four-way Butler Matrix feed network to create only three antenna beams. This can be accomplished by adding an additional 45° phase progression across the feed network as disclosed in U.S. Pat. No. 6,353,410 so that the effective phase progressions are −90°, 0° and +90°. Splitting the outputs of a Butler Matrix feed network as disclosed herein is compatible with the techniques disclosed in U.S. Pat. No. 6,353,410.

It can be appreciated that larger Butler Matrix feed networks, such as six-way or eight-way feed networks, would have the same periodicity of three-way and four-way feed networks. Therefore, the principles of the invention can be applied to larger Butler Matrix feed networks by splitting their antenna ports in a similar fashion. Employing the inventive concepts in larger feed networks would produce very narrow beam antennas with many beams.

The power divisions disclosed in the various embodiments are believed to achieve a typical amplitude taper that would provide side lobe suppression. However, larger or smaller dividers could be used to create different power divisions and thereby adjust the amplitude taper and the resulting side lobe levels to desired values for a particular application.

While the above embodiments include an equal number of dipoles per column/array and such a configuration is viewed by the inventors as the best balance between gain and sidelobe suppression, if a more sidelobe suppression is desired, an antenna system according to the invention may be configured such that the number of dipoles per column/array progressively decreases from the center to the edge of the antenna. In other words, an antenna may be configured such that a center array or central arrays include a greater number of dipoles than the outer arrays, and outermost arrays include the fewest number of dipoles. Such configurations are disclosed in U.S. Pat. No. 6,353,410 to Powell, for example.

It should be understood that the devices and methods disclosed herein are merely exemplary embodiments of the invention. One of ordinary skill in the art will appreciate that changes and variations to the disclosed embodiments can be made without departing from the spirit and scope of the inventions as set forth in the appended claims.

We claim:

1. An antenna system comprising:
a multi-beam antenna comprising a plurality of co-linear arrays positioned with respect to an electrically conductive backplane, each co-linear array of the plurality of co-linear arrays comprising one or more electromagnetic radiating elements, and the plurality of co-linear arrays comprising at least one central co-linear array and two outer co-linear arrays positioned outside of the at least one central co-linear array;
a phased array feed network comprising,
a plurality of radio receiver/transmitter ports configured to connect to at least one radio receiver or transmitter, and
a plurality of antenna ports configured to connect to the plurality of co-linear arrays; and
one or more power dividers/combiners configured to connect one or more designated antenna ports among the plurality of antenna ports to at least two co-linear arrays among the at least one central co-linear array and the two outer co-linear arrays, the one or more power dividers/combiners being configured to split a signal power of the one or more designated antenna ports to decrease signal power provided to the antenna from the at least one central co-linear array to the two outer co-linear arrays.

2. The antenna system of claim 1, wherein the phased array feed network comprises a Butler Matrix feed network.

3. The antenna system of claim 1, wherein the one or more electromagnetic radiating elements comprise one or more dipole radiating elements.

4. The antenna system of claim 1, wherein:
the plurality of antenna ports comprises three antenna ports;
the one or more power dividers/combiners comprise a power divider/combiner;
the at least one central co-linear array comprises two central co-linear arrays; and
the antenna system is configured to provide each of the two central co-linear arrays a first amount of power, and provide each of the two outer co-linear arrays a second amount of power that is lower than the first amount of power.

5. The antenna system of claim 4, wherein the second amount of power is approximately one-half of the first amount of power.

6. The antenna system of claim 1, wherein:
the plurality of antenna ports comprises three antenna ports;
the one or more power dividers/combiners comprise two power dividers/combiners;
the at least one central co-linear array comprises a first central co-linear array, a second central co-linear array adjacent to the first central co-linear array, and a third central co-linear array adjacent to the second central co-linear array; and
the antenna system is configured to provide the second central co-linear array a first amount of power, provide each of the first central co-linear array and the third central co-linear array a second amount of power that is less than the first amount of power, and provide each of the two outer co-linear arrays a third amount of power less that is lower than the first amount of power.

7. The system of claim 6, wherein the second amount of power is approximately two-thirds of the first amount of power and the third amount of power is about one-third of the first amount of power.

8. The antenna system of claim 1, wherein:
the plurality of antenna ports comprises three antenna ports;
the one or more power dividers/combiners comprise three power dividers/combiners;
the at least one central co-linear array comprises first central co-linear array, a second central co-linear array adjacent to the second co-linear central array, a third central co-linear array adjacent to the second central co-linear array and a fourth central co-linear array adjacent to the third central co-linear array; and
the antenna system is configured to provide the first and fourth central co-linear arrays a first amount of power, provide the second and third central co-linear arrays a second amount of power that is lower than the first amount of power, and provide each of the two outer co-linear arrays a third amount of power that is lower than the second amount of power.

9. The antenna system of claim 9, wherein the second amount of power is about one-half of the first amount of power and the third amount of power is approximately four-sevenths of the first amount of power.

10. The antenna system of claim 1, wherein:
the plurality of antenna ports comprises four antenna ports;
the one or more power dividers/combiners comprises a power divider/combiner;
the at least one central co-linear array comprises a first central co-linear array, a second central co-linear array adjacent to the first central co-linear array, and a third central co-linear array adjacent to the second central co-linear array; and
the antenna system is configured to provide each of the first central co-linear array, the second central co-linear array and the third central co-linear array a first amount of power, and provide each of the two outer co-linear arrays a second amount of power less that is lower than the first amount of power.

11. The system of claim 10, wherein the second amount of power is approximately one-half of the first amount of power.

12. The antenna system of claim 1, wherein:
the plurality of antenna ports comprises four antenna ports;
the one or more power dividers/combiners comprise two power dividers/combiners;
the at least one central co-linear array comprises first central co-linear array, a second central co-linear array adjacent to the first central co-linear array, a third central co-linear array adjacent to the second central co-linear array and a fourth central co-linear array adjacent to the third central co-linear array; and
the antenna system is configured to provide the first and fourth central co-linear arrays a first amount of power, provide the second and third central co-linear arrays a second amount of power that is lower than the first amount of power, and provide each of the two outer co-linear arrays a third amount of power that is lower than the second amount of power.

13. The system of claim 12, wherein the second amount of power is approximately two-thirds of the first amount of power and the third amount of power is about one-third of the first amount of power.

14. The system of claim 1, wherein:
the plurality of antenna ports comprises four antenna ports;
the one or more power dividers/combiners comprise three power dividers/combiners;
the at least one central co-linear array comprises first central co-linear array, a second central co-linear array adjacent to the first co-linear central array, a third central co-linear array adjacent to the second central co-linear array, a fourth central co-linear array adjacent to the third central co-linear array, and a fifth central co-linear array adjacent to the fourth central co-linear array; and
the antenna system is configured to provide the third central co-linear array a first amount of power, provide each of the second and fourth central co-linear arrays a second amount of power that is lower than the first amount of power, provide each of the first and fifth central co-linear arrays a third amount of power that is lower than the second amount of power, and provide each of the two outer co-linear arrays a fourth amount of power that is lower than the third amount of power.

15. The antenna system of claim 14, wherein the second amount of power is approximately three-fourths of the first amount of power, the third amount of power is approximately one-half of the first amount of power, and the fourth amount of power is approximately one-fourth of the first amount of power.

16. The antenna system of claim 1, wherein:
the plurality of antenna ports comprises four antenna ports;
the one or more power dividers/combiners comprise four power dividers/combiners;
the at least one central co-linear array comprises first central co-linear array, a second central co-linear array adjacent to the first co-linear central array, a third central co-linear array adjacent to the second central co-linear array, a fourth central co-linear array adjacent to the third central co-linear array, a fifth central co-linear array adjacent to the fourth central co-linear array, and a sixth central co-linear array adjacent to the fifth central co-linear array; and
the antenna system is configured to provide each of the third and fourth central co-linear arrays a first amount of power, provide each of the second and fifth central co-linear arrays a second amount of power that is lower than the first amount of power, provide each of the first and sixth central co-linear arrays a third amount of power that is lower than the second amount of power, and provide each of the two outer co-linear arrays a fourth amount of power that is lower than the third amount of power.

17. The antenna system of claim 16, wherein the second amount of power is approximately seven-ninths of the first amount of power, the third amount of power is approximately seven-eighteenths of the first amount of power, and the fourth amount of power is approximately one-sixth of the first amount of power.

18. The antenna system of claim 1, wherein the one or more electromagnetic radiating elements are of equal number in each co-linear array of the plurality of co-linear arrays.

19. A method of operating an antenna system, comprising:
implementing a multi-beam antenna comprising a plurality of co-linear arrays positioned with respect to an electrically conductive backplane, each co-linear array of the plurality of co-linear arrays comprising one or more electromagnetic radiating elements, and the plurality of co-linear arrays comprising at least one central co-linear array and two outer co-linear arrays positioned outside of the at least one central co-linear array;
implementing a phased array feed network comprising,
a plurality of radio receiver/transmitter ports configured to connect to at least one radio receiver or transmitter, and
a plurality of antenna ports configured to connect to the plurality of co-linear arrays; and
using one or more power dividers/combiners to connect one or more designated antenna ports among the plurality of antenna ports to at least two co-linear arrays among the at least one central co-linear array and the two outer co-linear arrays; and
operating the one or more power dividers/combiners to split a signal power of the one or more designated antenna ports and thereby decrease signal power provided to the antenna from the at least one central co-linear array to the two outer co-linear arrays.

20. The method of claim 19, wherein the one or more electromagnetic radiating elements are of equal number in each co-linear array of the plurality of co-linear arrays.
